(19) United States
(12) Patent Application Publication
(10) Pub. No.: US 2015/0353729 A1
(43) Pub. Date: Dec. 10, 2015

(54) Biodegradable Synthetic Polymer Material

(71) Applicant: QUEENSBROOK LIMITED, Dublin (IE)

(72) Inventor: Madrisano Catinari, Civitanova Marche (IT)

(21) Appl. No.: 14/760,299

(22) PCT Filed: Jan. 7, 2014
(86) PCT No.: PCT/IB2014/058097

§ 371 Date: Jul. 10, 2015

(30) Foreign Application Priority Data
Jan. 10, 2013 (IT) MI2013A000004

(51) Int. Cl. C08L 75/04; C08L 31/04; C08L 27/06; C08L 23/06

(52) U.S. Cl. CPC C08L 75/04; C08L 23/06; C08L 31/04; C08L 27/06

(57) ABSTRACT

A biodegradable synthetic polymer material obtained synthetically and to which sucrose has been added is disclosed. A process for the preparation of a biodegradable synthetic polymer material is also disclosed which provides the steps of: a) causing the starting monomers to polymerise under the usual conditions of macromolecule organic chemistry, until reaching the desired molecular weight; b) mixing the polymer obtained and the sugar in the desired proportions; c) proceeding to the usual subsequent processing.

### TECHNICAL FIELD

The present invention relates to a biodegradable synthetic polymer material, which may be obtained starting from a synthetic and per-se non-biodegradable polymer, and to a process for the obtaining thereof.

### BACKGROUND OF THE INVENTION

It is well-known that plastic materials, owed to the extremely high versatility, the low cost and the mechanical and processing properties thereof, have spread on the market in an impressive manner, permeating virtually any field of our daily life. It is furthermore known that precisely the chemical resistance of these materials—a property which makes them particularly attractive to the industry—however, also makes the disposal thereof difficult, since enormously long times are necessary for the degradation thereof, so that a real soiling problem arises due to the plastic material waste, the mass of which is continuously increasing. The combustion thereof, moreover, often leads to the development of toxic substances.

Various attempts have been made to try and solve this problem, which is taking up increasingly serious proportions.

In a first moment it has been attempted to create plastic materials which are water-soluble, so that the immission thereof in the sea or the exposure thereof to the rains would lead to the disappearance thereof. However, such materials, in addition to being less versatile, precisely due to the solubility thereof (being fully unsuitable for certain uses, for example outdoors), did solve the soiling problem, however, causing pollution of the waterways and of the water resources in general.

In a subsequent step, it was attempted to manufacture photodecomposable plastic materials which, exposed to the light, tended to decompose into the monomer constituents thereof. However, this solution too often led to greater pollution, since the monomers are often toxic agents and, in any case, it was not possible to control the diffusion of the decomposition products in the soil and in the water tables.

Starch-based plastic materials have been manufactured later and are still widely used, such as for example Novamont's so-called, MaterBi®. However, in addition to raising problems related to the fact that they use massive amounts of foodstuffs as raw materials (thus diverting them from their main and vital use), they exhibited a stiffness which made them unsuitable for most uses.

PCT/IT2005/000166 and Italian application no. AN2008A 000024 suggested the use with MaterBi and similar materials of suitable natural plasticisers, which managed to solve the stiffness problem, making these starch-based materials sufficiently resilient to allow the use thereof in the most diverse applications. However, such plastic materials cost remarkably more than the common synthetic polymer materials which, for this reason, still remain the favourite materials at industrial level.

With Italian patent application no. AN2008A 000013 it was suggested to functionalise with proteins most of the synthetic plastic materials, so as to make them biodegradable. However, the results obtained in this way are fully unsatisfactory, since the products obtained have not proved sufficiently biodegradable.

Italian patent application no. AN2010A 000002 suggests a synthetic polymer material, consisting of a synthetic polymer or copolymer to which yeasts are added, thus contributing to make the overall material biodegradable. Although the cost of these materials is remarkably lower than that of the previous products, however, yeasts still make up a relatively expensive material and tend to leave on the final plastic material a not always pleasant smell. Sometimes, furthermore, there is an undesired colouring of the material obtained. Finally, from a technical point of view, yeasts cannot be granulated nor melted.

WO2010/043 293 describes cellulose polymers, the biodegradability of which, already present therein naturally, is increased by the addition of inorganic compounds, such as nitrogen, phosphorus and sulphur and of one or more sugars.

WO99/009 354 and U.S. Pat. No. 5,212,219 described composite materials of polymers comprising a saturated stable polymer, normally polyethylene, an unsaturated, less stable polymer (with self-oxidising properties), a temporary stabiliser to oxidation and an oxidant. Such composite materials may contain also starches acting as strengthening fibres, and possibly sugars. In the text it is clearly explained that the biodegradability is given by the combination of unsaturated/oxidant polymers. Moreover, the oxidants are based on salts of heavy metals, hence not particularly environmentally friendly. No indication is reported in the patent on the opportunity of obtaining the biodegradation of the saturated polymer component without the unsaturated component and without salts of heavy metals; no special function is furthermore attributed to sugars, but a vague structural strengthening function.

WO00/59 996 describes a process for producing polymers, inserting in the fluid polymer a degrading agent, among which glucose derivatives.

WO03/051 989 discloses a process for making biodegradable synthetic polymers adding—among other things—sugars. However, this prior art document discloses a potentially huge number of polymers and of additives. That is, the range of polymers and additives made available is so vast as not to allow to understand if there are polymers and/or additives which provide particularly convincing results.

### BRIEF DESCRIPTION OF THE INVENTION

The problem at the basis of the invention is to propose a biodegradable synthetic polymer material which overcomes the mentioned drawbacks and which allows the normal processes of conventional synthetic plastic materials, without excessively increased costs and which achieves as fast and complete a degradation as possible. This object is achieved through a biodegradable synthetic polymer material, characterised in that it is a polymer obtained synthetically, chosen in the group comprising polyvinyl chloride (PVC), ethylene vinyl-acetate (EVA), thermo-plastic polyurethane (TPU) and polyethylene (PE) mixed with sucrose. The present invention relates also to a process for the production of these materials.

### BRIEF DESCRIPTION OF THE DRAWINGS

FIG. 1 is a photograph showing the result of an example according to the present invention; and

FIGS. 2 and 3 are photographs showing the results of comparative examples, according to the prior art.

### BEST WAY OF CARRYING OUT THE INVENTION

As seen, the present invention relates to a synthetic polymer material chosen in the group comprising polyvinyl chloride (PVC), ethylene vinyl-acetate (EVA), thermo-plastic polyurethane (TPU) and polyethylene (PE), which is made biodegradable by the addition of sucrose. Sucrose may be obtained easily and relatively cheaply, both from beetroot and from sugar cane. The sucrose percentage may vary from 0.3% by weight to 10% by weight, both relating to the total weight of the final material, preferably from 0.5 to 5% by weight, particularly preferrably from 1 to 2.5% by weight, always referred to the total weight of the final material. If the sucrose content is below 0.3% by weight, the biodegradation effect is virtually negligible, while if sucrose exceeds 10% by weight, there is excessive embrittlement of the plastic material obtained.

Particularly advantageous results have been obtained using a sucrose to which a starch had been added. In particular, a starch addition between 1 and 5% by weight is advantageous, preferably of 3% by weight. Without wanting to be bound to theory, it seems that this starch addition reduces sucrose hygroscopicity, so that the distribution thereof in the polymer is improved thereby.

Obviously, the polymer material according to the present invention may contain other additives, commonly used in the practice of the field. In particular, the material may contain plasticisers, flame-retardants, reinforcing fibres (such as glass fibre and carbonfibre), dyes, deodorants, fragrances, lubricants, detaching agents. The polymer material according to the present invention may contain also other substances apt to make it biodegradable, such as yeasts.

Since the synthetic polymer makes up at least 90% (and, in most cases, at least 95%) of the final total polymer material, although sugars are substances suitable for nutrition, consumption thereof will not be excessive and the material can be considered environmentally friendly.

As regards the preparation methods of the biodegradable polymer material according to the present invention, the process provides the steps of: a) causing the starting monomers to polymerise under the usual conditions of macromolecule organic chemistry, until reaching the desired molecular weight; b) mixing the obtained polymer and sucrose in the desired proportions; c) proceeding to the usual subsequent processing.

Sucrose, in step b), may be added in powder or granule form, since it is easily granulated. The mixing may occur upon granulation. Powder sucrose may be added, for example, in the desired amount, to the polymer flakes obtained during the polymerisation and coextrude the material to form granules of polymer material according to the present invention. Alternatively, granules of polymer and granules of sucrose may be obtained separately and they may be mixed in the due proportions before melting for the subsequent processing, for example before injection moulding or extrusion moulding.

Finally, it is possible to proceed to the separate melting of polymer and sucrose and to the mixing of the molten material in the due proportions upon moulding. The melting temperature of sucrose, ranging between 180° C. and 200° C., causes it to melt at the standard processing temperature of polymers, so that the standard processing conditions of these materials must not necessarily be changed. The addition of any other additives occurs in the times and ways usual in the field and are not affected by the presence of sucrose nor of the starch possibly added thereto.

### EXAMPLES

The present invention is further illustrated based on the following preparation examples, with a purely non-limiting illustrative object.

### Example 1

Polyethylene granules were mixed with sucrose granules.

Sucrose made up 2% by weight of the total. The mixture was melted at 180° C. and injection-moulded to form a polyethylene sheet according to the present invention. The sheet of polymer material thus obtained was subjected to a biodegradability test for 33 days according to ISO standard 148551:2005, at the end of which 11.5% of the polyethylene appeared degraded.

### Example 2

Example 1 was repeated, apart from the fact that the polyethylene was replaced with ethylene vinyl-acetate (EVA).

After 33 days the biodegradation was 13%.

### Example 3

Example 1 was repeated, but instead of polyethylene thermo-plastic polyurethane was used.

After 33 days the degradation was 20%.

### Example 4

Example 1 was repeated, but instead of polyethylene polyvinyl chloride was used.

After 33 days the degradation was of 37%.

### Example 5

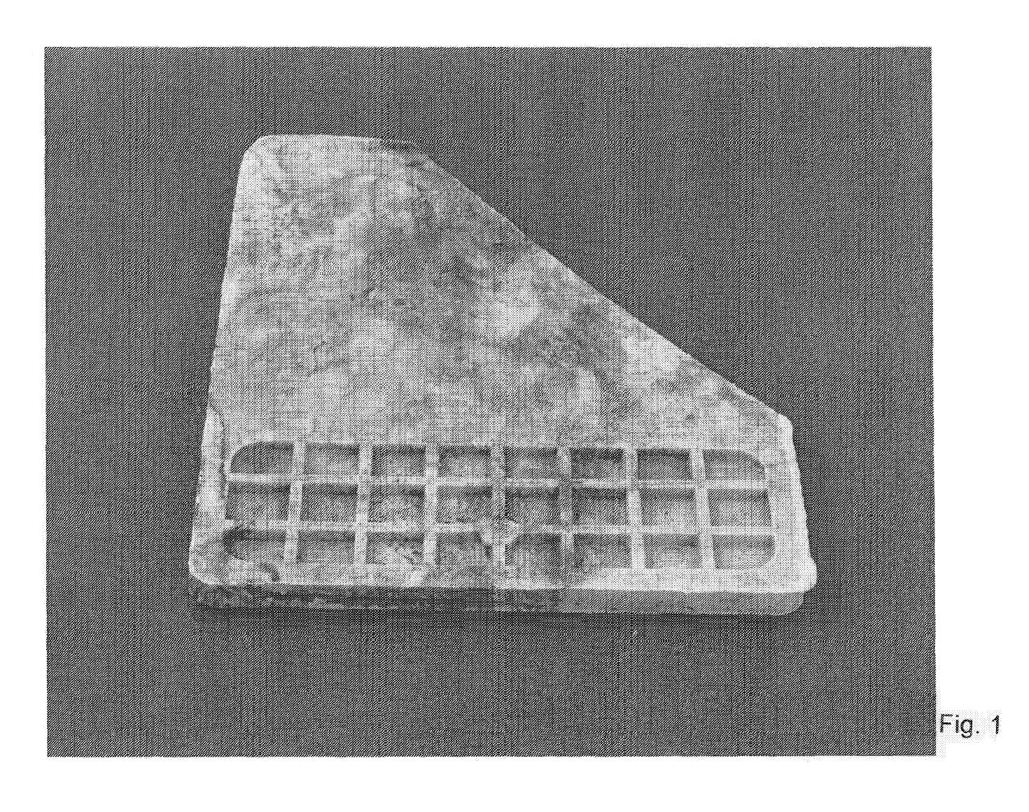

Example 4 was repeated, employing sucrose with 3% by weight of starch and the degradation was made to continue for 60 days. The sample obtained is shown at the end of the 60 days in FIG. 1. It can be noticed that the degradation is rather advanced.

### Comparative Example 1

Example 5 was repeated, but polyvinyl chloride was replaced by styrene-butadiene-styrene copolymer (SBS).

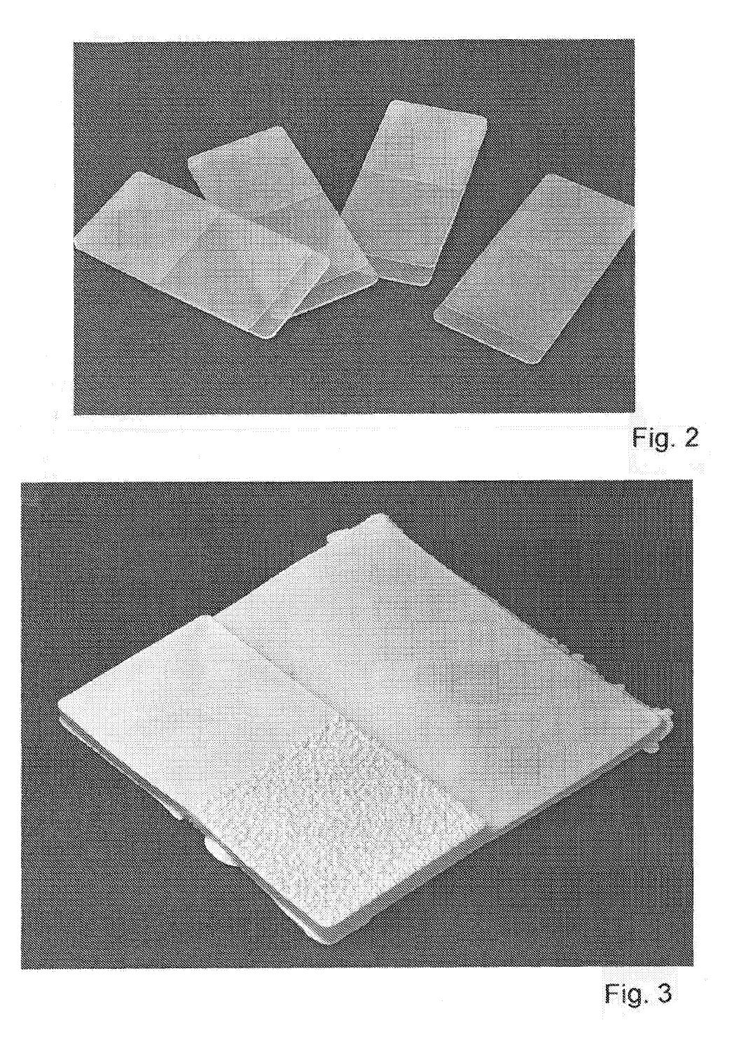

The samples obtained were subjected to the degradation conditions for 60 days. The samples at the end of the 60 days are shown in FIG. 2, from which it can be seen that degradation has not occurred.

### Comparative Example 2

Example 5 was repeated, but polyvinyl chloride was replaced by polypropylene and starch-added sucrose with glucose. The sample obtained was subjected to the degradation conditions for 60 days. The sample at the end of the 60 days is shown in FIG. 3. It can be seen that degradation is very poor.

From the above examples it is clear that in all cases there is biodegradation activity.

The present invention therefore allows to obtain highly biodegradable polymers, starting from synthetic polymers, hence obtainable starting from the common fossil sources of raw material, using modest additions of a component normally meant for human consumption, so as not to cause damage to nutrition; it must also be considered that the present invention makes available materials obtainable extremely simply. The present invention allows to solve all the problems left open by the previous solutions. In particular, the final product is remarkably better than the product which may be obtained according to Italian application AN2010A 000002, since the addition of sucrose, compared to that of yeast, has the following advantages: A) sucrose may be granulated, which leads to a format of the additive more welcome to the manufacturers of items made of plastic material; B) yeasts leave a rather unpleasant odour also in the final material, while sucrose leaves no smell or, at most, leaves a light and pleasant caramel smell; C) sucrose may be melted together with polymer granules; D) sucrose does not affect the colour of the finished product; sucrose does not affect the mechanical properties of the finished product.

From the comparative examples biodegradability is also much more accentuated in the products of the present invention than some of the products which may be obtained according to WO03/051 989, proving the inventive step of the selection made by the present invention.

Anyway, it is understood that the invention must not be considered limited to the special arrangement illustrated above, which makes up only an exemplifying embodiment thereof, but that different variants are possible, all within the reach of a person skilled in the field, without departing from the scope of the invention, as defined by the following claims.

1) Biodegradable synthetic polymer material, characterised in that it is a polymer obtained synthetically, chosen in the group comprising polyvinyl chloride (PVC), ethylene vinyl-acetate (EVA), thermo-plastic polyurethane (TPU) and polyethylene (PE) with which sucrose has been mixed.

2) Biodegradable synthetic polymer material as claimed in 1), characterised in that the sucrose percentage contained therein varies from 0.3% by weight to 10% by weight, both referring to the total weight of final material.

3) Biodegradable synthetic polymer material as claimed in 2), characterised in that the sucrose percentage contained therein varies from 1 to 2.5% by weight, referred to the total weight of final material.

4) Biodegradable synthetic polymer material as claimed in any one of the preceding claims, characterised in that said sucrose also contains a starch.

5) Biodegradable synthetic polymer material as claimed in 4), characterised in that said starch is added to the sucrose in an amount ranging between 1 and 5% by weight.

6) Biodegradable synthetic polymer material as claimed in 5), characterised in that said starch is added to the sucrose in an amount of 3% by weight.

7) Biodegradable synthetic polymer material as claimed in any one of the preceding claims, characterised in that it also contains other agents apt to make it biodegradable, such as yeasts.

8) Process for the preparation of a biodegradable synthetic polymer material, characterised in that it provides the steps of: a) causing the starting monomers to polymerise, under the usual conditions of macromolecule organic chemistry, until reaching the desired molecular weight to obtain polymers chosen in the group comprising polyvinyl chloride (PVC), ethylene vinyl-acetate (EVA), thermo-plastic polyurethane (TPU) and polyethylene (PE); b) mixing in the desired proportions the polymer obtained and sucrose; c) proceeding to the usual subsequent processing.

9) Process as claimed in 8), characterised in that step b) occurs upon granulation, adding powdered sugar, in the desired amounts, to the polymer flakes obtained during the polymerisation, and coextruding the material to form granules of polymer material according to the present invention.

10) Process as claimed in 9), characterised in that step b) is performed mixing in the due proportions-polymer granules and sucrose granules before melting for the subsequent processing.

11) Process as claimed in 8), characterised in that step b) is performed proceeding to the separate melting of polymer and sucrose and to the mixing of the molten material in the due proportions upon the subsequent processing.
